(19) United States
(12) Patent Application Publication
(10) Pub. No.: US 2013/0325204 A1
(43) Pub. Date: Dec. 5, 2013

(54) PROCEDURE AND MONITORING DEVICE FOR SUPERVISING AN ENTERPRISE OF A VEHICLE

(71) Applicant: GM GLOBAL TECHNOLOGY OPERATIONS LLC, Detroit, MI (US)

(72) Inventors: Heiko BALD, Modautal (DE); Aiko BOEHME, Ingelheim (DE)

(21) Appl. No.: 13/828,838

(22) Filed: Mar. 14, 2013

(30) Foreign Application Priority Data
Jun. 5, 2012 (DE) 102012011154.1

(51) Int. Cl. G06F 17/00

(52) U.S. Cl. CPC G06F 17/00
USPC 701/1

(57) ABSTRACT

A method for monitoring an operation of a vehicle is provided, wherein said method features the following steps. At least one first parameter is determined, wherein the at least one first parameter characterizes the beginning of a starting sequence of the vehicle. In addition, at least one intoxicant content of the person seated in the driver's seat is determined by means of a test instrument and the determined content is compared with a predefined threshold value. If the determined content does not exceed the predefined threshold value, the starting sequence of the vehicle is automatically enabled and it is detected if the person seated in the driver's seat leaves the driver's seat based on data acquired by at least one sensor. The determination of the at least one intoxicant content is repeated if it is detected that the person seated in the driver's seat leaves the driver's seat.

### CROSS-REFERENCE TO RELATED APPLICATION

This application claims priority to German Patent Application No. 10 2012 011 154.1, filed Jun. 5, 2012, which is incorporated herein by reference in its entirety.

### TECHNICAL FIELD

The application pertains to a method and a monitoring device for monitoring an operation of a vehicle, a computer program product and a machine-readable medium.

### BACKGROUND

DE 10 2007 047 709 A1 discloses a device for preventing a driver, who is under the influence of alcohol, from starting or operating a vehicle, particularly a motor vehicle. The device comprises an instrument for determining the alcohol content in the breath, blood, tissue, perspiration or tissue fluid of the driver, as well as an immobilizer system that prevents the driver from starting or operating the vehicle if the alcohol content in the breath, blood, tissue, perspiration or tissue fluid of the driver determined by the instrument exceeds a predefined threshold value. Means for bypassing or deactivating the immobilizer system are provided.

In addition, other objects, desirable features and characteristics will become apparent from the subsequent summary and detailed description, and the appended claims, taken in conjunction with the accompanying drawings and this background.

### SUMMARY

The teachings of the present application provide a method for monitoring an operation of a vehicle, a monitoring device for a vehicle in order to monitor an operation of the vehicle, a computer program product and a machine-readable medium that allow additionally improved monitoring of the operation of the vehicle and, in particular, of a starting sequence of the vehicle.

According to one exemplary aspect of the application, a method for monitoring an operation of a vehicle features the following steps. At least one first parameter is initially determined, wherein the at least one first parameter characterizes a beginning of a starting sequence of the vehicle. In addition, at least one intoxicant content of the person seated in the driver's seat of the vehicle is determined by means of a test instrument and the determined content is compared with a predefined threshold value. If the determined content does not exceed the predefined threshold value, the starting sequence of the vehicle is automatically enabled and it is detected if the person seated in the driver's seat of the vehicle, whose at least one intoxicant content was determined, leaves the driver's seat based on data acquired by at least one sensor of the vehicle. If it is detected that the person seated in the driver's seat of the vehicle, whose at least one intoxicant content was determined, leaves the driver's seat, the determination of the at least one intoxicant content is repeated on the person subsequently seated in the driver's seat of the vehicle.

The method according to the described embodiment allows additionally improved monitoring of the operation of the vehicle and, in particular, of the starting sequence of the vehicle. This is realized by determining at least one intoxicant content of the person seated in the driver's seat of the vehicle, by detecting if the person seated in the driver's seat of the vehicle, whose at least one intoxicant content was determined, leaves the driver's seat and, if this is the case, by repeating the determination of the at least one intoxicant content on the person subsequently seated in the driver's seat of the vehicle. The described embodiment is based on the notion that a driver change may occur if the person, whose at least one intoxicant content was determined, leaves the driver's seat. In order to prevent persons from evading the aforementioned test, the determination of the at least one intoxicant content therefore is repeated or carried out anew. This makes it possible to ensure, in particular, that the person who was tested for the at least one intoxicant and whose determined content does not exceed the predefined threshold value actually is the person who subsequently starts and operates or drives the vehicle. The proposed method therefore cannot be evaded by another person carrying out the test for determining the at least one intoxicant content. The method therefore can be carried out in a manipulation-proof fashion such that an important prerequisite for the release or approval of the method, particularly by regulatory authorities, can be advantageously fulfilled.

In one embodiment, a drive unit of the vehicle also is automatically restricted if it is detected that the person seated in the driver's seat of the vehicle, whose at least one intoxicant content was determined, leaves the driver's seat. If the vehicle was not yet started, for example, the starting sequence of the drive unit of the vehicle is automatically blocked. This may take place, in particular, for at least the duration of the repeated determination. If the vehicle was already started, it is also possible to reduce the maximum power output of the drive unit and/or the instantaneous power output of the drive unit. In addition, the maximum speed of the vehicle can be reduced. The drive unit furthermore can be automatically deactivated. In these instances, the operation of the vehicle consequently is at least temporarily restricted in an automated fashion.

The at least one sensor may be realized in the form of a seat occupancy sensor, wherein the seat occupancy sensor is arranged in the driver's seat. The seat occupancy sensor may be realized, in particular, in the form of a weight sensor. Such a sensor makes it possible to easily determine if the person seated in the driver's seat of the vehicle leaves the driver's seat.

The at least one sensor may furthermore be realized in the form of an optical camera. Such a camera also makes it possible to easily and reliably determine if the person leaves the driver's seat.

In this case, the position of the face of the person is preferably determined in the images recorded by the optical camera by means of an image analysis. If it is determined that the face of the person is at least partially situated outside the acquisition range of the optical camera, for example for a predefined duration, at least one second parameter is determined in accordance with another embodiment, wherein the at least one second parameter characterizes the possibility of the driver leaving the driver's seat. This embodiment is based on the notion that the face of the person being at least partially situated outside the acquisition range of the optical camera, i.e., at least part of the face of the person not being illustrated in the images recorded by the optical camera, implies the possibility of the driver leaving the driver's seat. In this case, the at least one second parameter therefore is determined in order to ascertain if the person has actually left the driver's seat based on this second parameter.

The at least one second parameter therefore is preferably selected from the group comprising an open state of at least one door of the vehicle, particularly an open state of the driver's door and/or the front passenger door of the vehicle, and an actuation of the seat belt buckle of the driver's seat. The aforementioned parameters make it possible to easily determine if the person has actually left the driver's seat. For example, the driver's door and the front passenger door not having been opened while the face was not situated within the acquisition range implies that the person has not left the driver's seat. In addition, the seat belt of the driver's seat having been buckled during the time, in which the face was not illustrated in the recorded images, likewise implies that the person has not left the driver's seat.

In another embodiment, the face of the person situated in the area of the test instrument is also registered during the determination of the at least one intoxicant content by means of an image analysis of the images recorded by the optical camera. This makes it possible to reliably detect if the person, whose at least one intoxicant content was determined, corresponds to the person who subsequently drives the vehicle.

For this purpose, the test instrument preferably features at least one light source, wherein the at least one light source is activated at least during the determination of the at least one intoxicant content, and wherein the image analysis includes a determination of the position of the at least one light source in the images recorded by the optical camera. This makes it possible to easily register the test instrument and therefore the face of the person situated in the area of the test instrument in the recorded images. A light signal emitted by the at least one light source may furthermore feature a coding. This makes it possible to prevent manipulations of the user, i.e., the person to be tested, by utilizing a similar light source.

In one embodiment of the method, the at least one first parameter is selected from the group comprising a position of the ignition key of the vehicle and an actuation of a start button of the vehicle. The aforementioned parameters make it possible to reliably determine the beginning of a starting sequence of the drive unit of the vehicle, for example a driving motor, and therefore the beginning of the starting sequence of the vehicle itself

The determination of the at least one intoxicant content preferably includes a determination of the alcohol content of the person seated in the driver's seat of the vehicle. Consequently, a reliable and manipulation-proof method for preventing a person from driving the vehicle under the influence of alcohol is advantageously provided. This is particularly important for persons, whose driver's license was already suspended due to driving under the influence of alcohol. The above-described method makes it possible to prevent these persons from once again driving under the influence of alcohol.

The application also pertains to a monitoring device for a vehicle in order to monitor an operation of the vehicle. The monitoring device features a first determination unit that is designed for determining at least one first parameter, wherein the at least one first parameter characterizes the beginning of a starting sequence of the vehicle. The monitoring device also features a test instrument that is designed for determining at least one intoxicant content of the person seated in the driver's seat of the vehicle and for comparing the determined content with a predefined threshold value. The monitoring device furthermore features a second determination unit that is designed for detecting if the person seated in the driver's seat of the vehicle, whose at least one intoxicant content was determined, leaves the driver's seat based on data acquired by at least one sensor of the vehicle if the determined content does not exceed the predefined threshold value. In this case, the monitoring device is designed for automatically enabling the starting sequence of the vehicle if the determined content does not exceed the predefined threshold value. In addition, the monitoring device is designed for repeating the determination of the at least one intoxicant content if it is detected that the person seated in the driver's seat of the vehicle, whose at least one intoxicant content was determined, leaves the driver's seat.

The monitoring device according to the present application provides the advantages that were already described above with reference to the method according to the present application and are not individually cited again at this point in order to avoid repetitions.

In one embodiment of the monitoring device, the test instrument forms part of an ignition key of the vehicle. This advantageously makes it possible to reduce the number of additional components required for the monitoring device. However, the test instrument may also comprise a separate device, i.e., a device in the form of a supplementary unit.

The application furthermore pertains to a monitoring device for a vehicle in order to monitor an operation of the vehicle, wherein said monitoring device features means for determining at least one first parameter, and wherein the at least one first parameter characterizes the beginning of a starting sequence of the vehicle. In addition, the monitoring device features means for determining at least one intoxicant content of the person seated in the driver's seat of the vehicle, as well as means for comparing the determined content with a predefined threshold value. The monitoring device also features means for automatically enabling the starting sequence of the vehicle, as well as means for detecting if the person seated in the driver's seat of the vehicle, whose at least one intoxicant content was determined, leaves the driver's seat based on data acquired by at least one sensor of the vehicle if the determined content does not exceed the predefined threshold value. The monitoring device furthermore features means for repeating the determination of the at least one intoxicant content if it is detected that the person seated in the driver's seat of the vehicle, whose at least one intoxicant content was determined, leaves the driver's seat.

The application furthermore pertains to a computer program product that, when executed on an arithmetic computing unit of a vehicle, instructs the arithmetic computing unit to carry out the following steps. The arithmetic computing unit is instructed to determine at least one first parameter, wherein the at least one first parameter characterizes the beginning of a starting sequence of the vehicle. The arithmetic computing unit is also instructed to determine at least one intoxicant content of the person seated in the driver's seat of the vehicle by means of a test instrument and to compare the determined content with a predefined threshold value. If the determined content does not exceed the predefined threshold value, the arithmetic computing unit is instructed to automatically enable the starting sequence of the vehicle and to detect if the person seated in the driver's seat of the vehicle, whose at least one intoxicant content was determined, leaves the driver's seat based on data acquired by at least one sensor of the vehicle. If it is detected that the person seated in the driver's seat of the vehicle, whose at least one intoxicant content was determined, leaves the driver's seat, the arithmetic computing unit is instructed to repeat the determination of the at least one intoxicant content.

The application furthermore pertains to a machine-readable medium, on which a computer program product according to the above-described embodiment is stored.

The computer program product and the machine-readable medium according to the present application provide the advantages that were already described above with reference to the method according to the present application and are not individually cited again at this point in order to avoid repetitions.

The vehicle in the above-described embodiments generally is a motor vehicle, for example, a passenger car or a truck.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a flow chart of a method for monitoring an operation of a vehicle according to one embodiment of the application;

FIG. 2 shows a flow chart of a method for monitoring an operation of a vehicle according to one embodiment of the application;

FIG. 3 shows a vehicle, in which the method according to the application can be implemented, and

FIG. 4 shows a monitoring device according to an embodiment of the application for the vehicle illustrated in FIG. 3 in order to monitor an operation of the vehicle.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

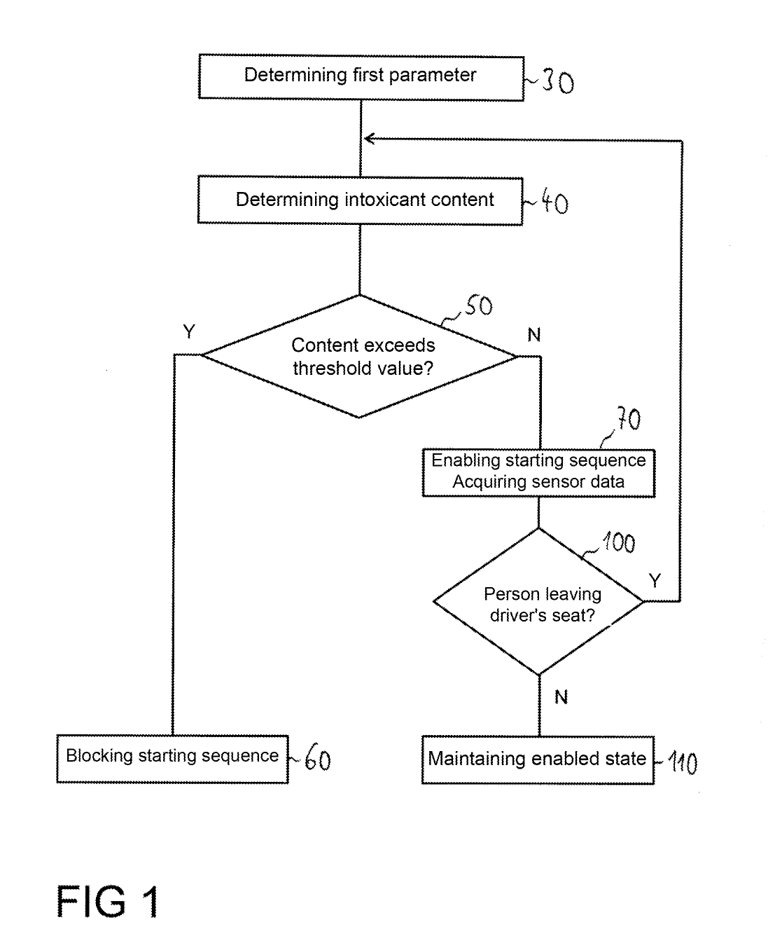

FIG. 1 shows a flow chart of a method for monitoring an operation and, in particular, a starting sequence of a vehicle according to a first embodiment of the application. The vehicle generally is a motor vehicle such as, for example, a passenger car.

At least one first parameter is determined in step 30, wherein the at least one first parameter characterizes the beginning of a starting sequence of the vehicle. The at least one first parameter is selected, for example, from the group comprising a position of the ignition key of the vehicle and an actuation of a start button of the vehicle. The starting sequence of the vehicle initially is not yet enabled if such a parameter that characterizes the beginning of a starting sequence of the vehicle is detected. Instead, the driver of the vehicle, i.e., the person seated in the driver's seat of the vehicle, is advised to carry out a test for at least one intoxicant such as, e.g., to provide a breath sample by outputting, for example, a corresponding optical and/or acoustical signal.

At least one intoxicant content of the person seated in the driver's seat of the vehicle is determined by means of a test instrument in step 40. The determination of the at least one intoxicant content preferably includes a determination of the alcohol content of the person seated in the driver's seat of the vehicle. For example, the driver or the person seated in the driver's seat respectively needs to deliver a breath sample into the test instrument for this purpose.

The determined content is furthermore compared with a predefined threshold value. In step 50, it is ascertained if the determined content exceeds the predefined threshold value.

If the determined content exceeds the predefined threshold value, the starting sequence of the vehicle is automatically blocked, i.e., the starting sequence of the vehicle is automatically aborted or interrupted, in step 60.

However, if it is ascertained in step 50 that the determined content does not exceed the predefined threshold value, the starting sequence of the vehicle is automatically enabled in step 70 and data is acquired by at least one sensor of the vehicle. In this case, the at least one sensor is realized, for example, in the form of a seat occupancy sensor arranged in the driver's seat or in the form of an optical camera.

In step 100, it is detected if the person seated in the driver's seat of the vehicle, whose at least one intoxicant content was determined, leaves the driver's seat based on the data acquired by at least one sensor of the vehicle.

If it is detected that the person seated in the driver's seat of the vehicle, whose at least one intoxicant content was determined, does not leave the driver's seat, the vehicle remains enabled as indicated in step 110.

However, if it is detected in step 100 that the person seated in the driver's seat of the vehicle, whose at least one intoxicant content was determined, leaves the driver's seat, the determination of the at least one intoxicant content is repeated, i.e., step 40 is carried out anew. In addition, a drive unit of the vehicle may also be automatically restricted in this case.

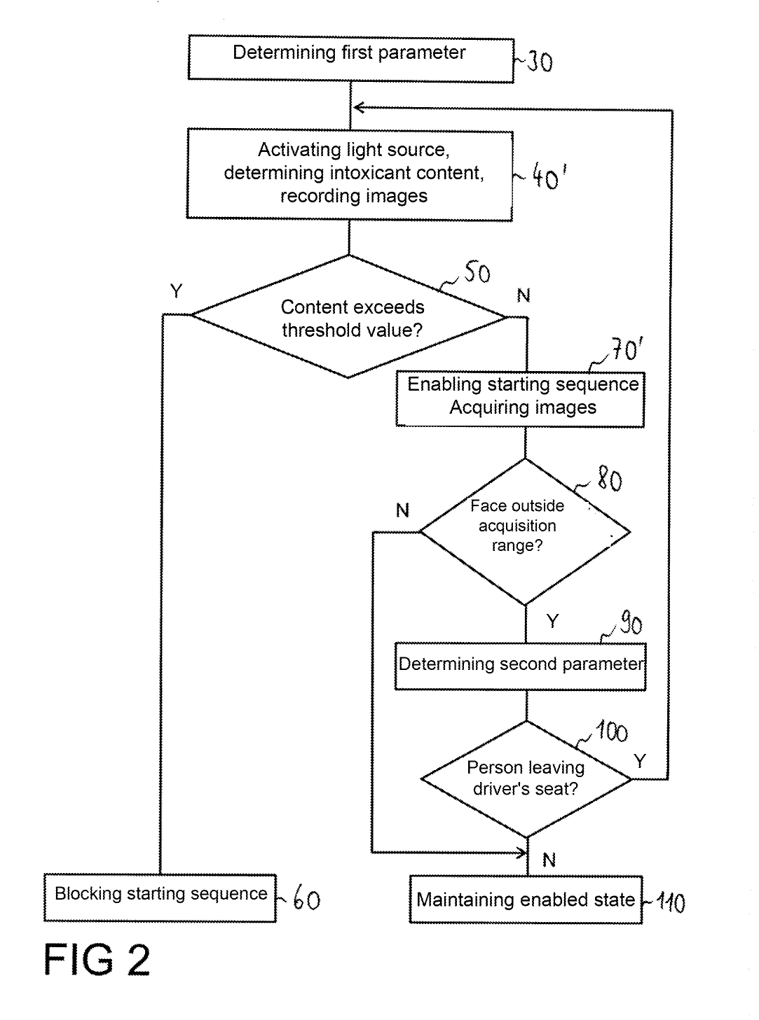

FIG. 2 shows a flow chart of a method for monitoring an operation and, in particular, a starting sequence of a vehicle according to an exemplary embodiment of the application. For example, the vehicle generally is once again a motor vehicle, for example, a passenger car.

At least one first parameter is determined in step 30, wherein the at least one first parameter characterizes the beginning of a starting sequence of the vehicle in accordance with step 30 of the exemplary embodiment illustrated in FIG. 1.

After detecting the beginning of a starting sequence, at least one intoxicant content of the person seated in the driver's seat of the vehicle is determined by means of a test instrument in step 40′. In addition, the face of the person situated in the area of the test instrument is also registered during the determination of the at least one intoxicant content by means of an image analysis of the images recorded by the optical camera. For this purpose, the optical camera is directed at the face of the driver when the driver is seated in the driver's seat. The camera may comprise the camera that is also used for detecting fatigue of the driver during the operation of the vehicle.

In the embodiment shown, the test instrument that may be integrated into the vehicle key, but also realized in the form of a separate device, features a light source such as, for example, a LED on its rear side. This light source is adapted to the spectral capabilities of the optical camera. The driver operates the test instrument while seated in the driver's seat. During its operation, the test instrument emits a light signal by means of the light source on its rear side. This light signal may contain a coding in order to prevent a manipulation by utilizing a similar light source. The light signal of the test instrument is detected by the camera that is respectively directed at the face of the driver or the face of the person seated in the driver's seat of the vehicle. In addition, the camera registers the face behind the test instrument. This is realized with an image analysis of the images recorded by the optical camera, wherein the image analysis includes a determination of the position of the light source in the recorded images. The face of the person situated in the area of the test instrument therefore is registered. In this case, it is not necessary to carry out an elaborate face recognition. It typically suffices to localize where the face of the person operating the test instrument is situated.

The above-described steps ensure that the result of a test such as, for example, an alcohol test is derived from the person who is respectively seated in the driver's seat of the vehicle and behind the steering wheel.

In step 50, the at least one determined intoxicant content is compared with a predefined threshold value in accordance with step 50 of the exemplary embodiment illustrated in FIG. 1.

If it is ascertained in step 50 that the determined content exceeds the predefined threshold value, the starting sequence of the vehicle is still automatically blocked in step 60. This is realized in accordance with step 60 of the exemplary embodiment illustrated in FIG. 1.

However, if it is ascertained in step 50 that the determined content does not exceed the predefined threshold value, the starting sequence of the vehicle drive unit is automatically enabled in step 70′ and the optical camera continues to record images. In this case, the position of the previously registered face is still determined in the recorded images by means of an image analysis.

In step 80, it is determined if the face of the person is at least partially situated outside the acquisition range of the optical camera, i.e., whether or not the face of the person is illustrated in the recorded images.

The face remaining in the same position, i.e., the face not being at least partially situated outside the acquisition range, implies that the recorded images still show the person who has carried out the test. In step 110, the vehicle therefore remains enabled in accordance with step 110 of the exemplary embodiment illustrated in FIG. 1.

However, if the registered face moves out of the angle of view of the camera, i.e., if it is determined that the face of the person is at least partially situated outside the acquisition range of the optical camera, and subsequently returns into the acquisition range, it is necessary to ascertain if the recorded images still show the same face or if the driver has changed. In the embodiment shown, at least one second parameter is determined in step 90 for this purpose, wherein the at least one second parameter characterizes the possibility of the driver leaving the driver's seat. The at least one second parameter is selected, for example, from the group comprising an open state of at least one door of the vehicle and an actuation of the seat belt buckle of the driver's seat.

In step 100, it is detected if the person seated in the driver's seat of the vehicle has left the driver's seat based on the at least one second parameter. In this case, particularly the following criteria imply that the recorded images still show the same person, i.e., that the person has not left the driver's seat:
the driver's door and the front passenger door were not opened during the time, in which the face was not situated within the acquisition range,
the seat belt of the driver's seat was buckled during the time, in which the face was not situated within the acquisition range.

The fulfillment of these criteria implies that the recorded images still show the same driver. The vehicle therefore remains enabled as indicated in step 110 if it is detected in step 100 that the person has not left the driver's seat.

However, if these criteria are not fulfilled, it is possible that the driver has changed and the test must to be repeated. The determination of the at least one intoxicant content therefore is repeated, i.e., step 40′ is carried out anew, if it is detected in step 100 that the person seated in the driver's seat of the vehicle has left the driver's seat.

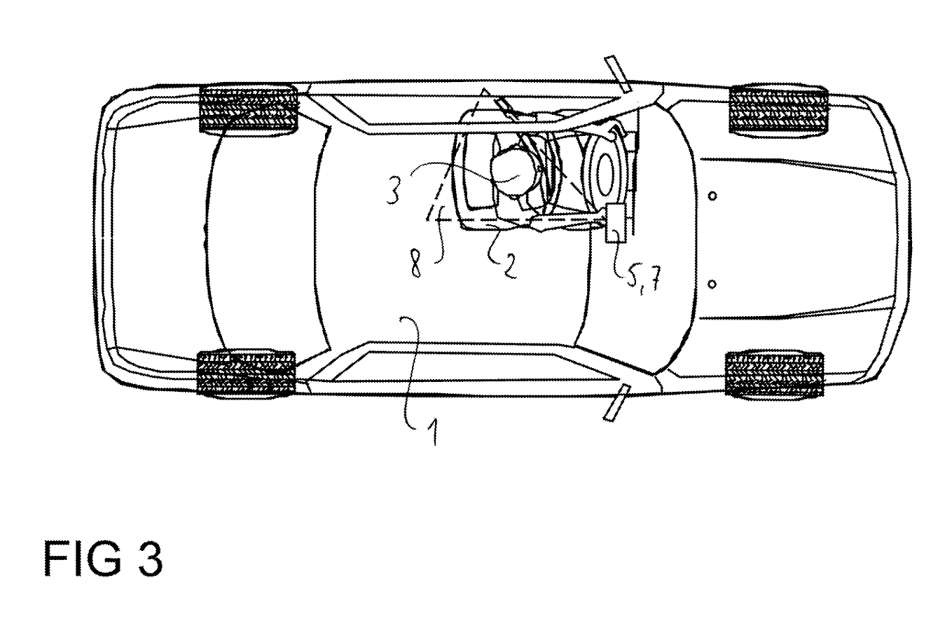

FIG. 3 shows a vehicle 1, in which the method according to the application, particularly the method according to the embodiments illustrated in FIGS. 1 and 2, can be implemented. In FIG. 3, part of the roof of the vehicle 1 is not illustrated in order to provide a better view of the interior of the vehicle 1.

The vehicle 1 is a motor vehicle in the form of a passenger car. A person 3 is seated in a driver's seat 2 of the vehicle 1. In this case, the person 3 is at least partially situated within the schematically indicated acquisition range 8 of a sensor 5 of the vehicle 1 in the form of an optical camera 7.

An operation and, in particular, a starting sequence of the vehicle 1 can be automatically monitored as described in greater detail below.

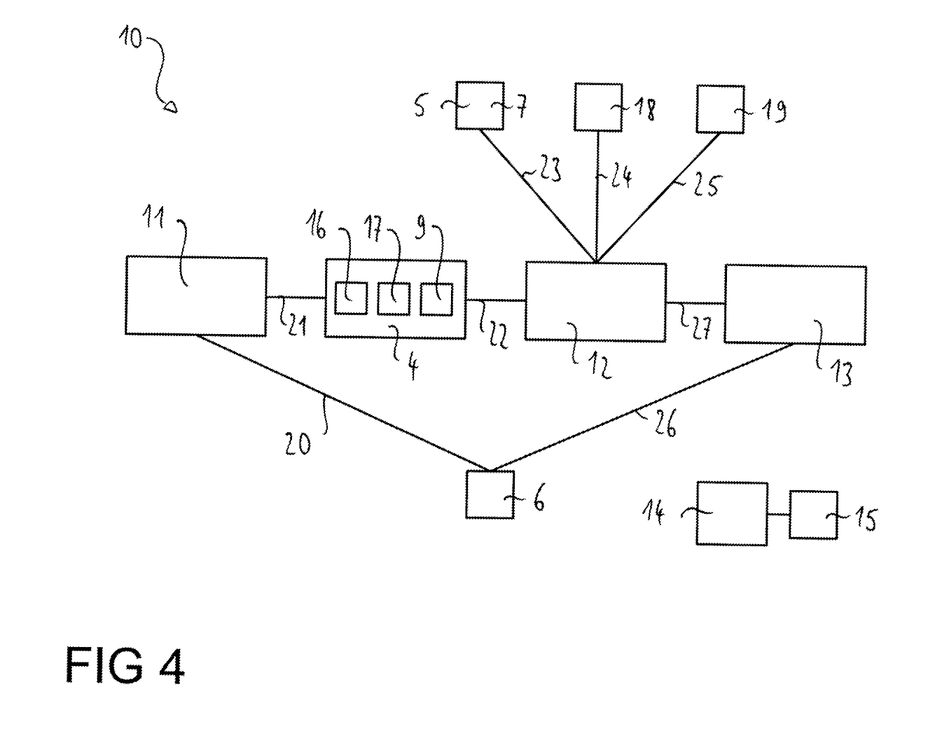

In this respect, FIG. 4 shows a monitoring device 10 of the vehicle illustrated in FIG. 3 according to one exemplary embodiment of the application. Components with the same functions as in FIG. 3 are identified by the same reference symbols and not elucidated again in the following description.

The monitoring device 10 features a first determination unit 11 that is designed for determining at least one first parameter, wherein the at least one first parameter characterizes the beginning of a starting sequence of the vehicle. In the embodiment shown, the first determination unit 11 is connected to a starter 6 of the vehicle via a signal line 20 for this purpose. For example, the position of the ignition key or an actuation of the start button of the vehicle may be detected in this case.

In addition, the monitoring device 10 features a test instrument 4 that is designed for determining at least one intoxicant content of the person seated in the driver's seat of the vehicle and for comparing the determined content with a predefined threshold value. The determination of the at least one intoxicant content preferably includes a determination of the alcohol content of the person seated in the driver's seat of the vehicle. For this purpose, the test instrument 4 that may, for example, form part of the ignition key of the vehicle contains an analyzing unit 16 for determining the at least one intoxicant content, as well as a storage device 17 for storing the predefined threshold value. In the embodiment shown, the test instrument 4 furthermore features at least one light source 9. The test instrument 4 is connected to the first determination unit 11 via a signal line 21.

The monitoring device 10 furthermore features a second determination unit 12 that is designed for detecting if the person seated in the driver's seat of the vehicle, whose at least one intoxicant content was determined, leaves the driver's seat. For this purpose, the second determination unit 12 is connected to the sensor 5 in the form of an optical camera 7 via a signal line 23. The second determination unit 12 is also connected to a sensor 18 designed for detecting an open state of at least one door of the vehicle, particularly a driver's door, via a signal line 24. Furthermore, the second determination unit 12 is connected to a sensor 19 of a seat belt buckle of the driver's seat via a signal line 25 in order to detect, in particular, when the seat belt buckle of the driver's seat is opened. The second determination unit 12 is also connected to the test instrument 4 via a signal line 22.

The monitoring device 10 is designed for automatically enabling the starting sequence of the vehicle if the determined content does not exceed the predefined threshold value. The monitoring device 10 is furthermore designed for repeating the determination of the at least one intoxicant content if it is detected that the person seated in the driver's seat of the vehicle, whose at least one intoxicant content was determined, leaves the driver's seat.

In the embodiment shown, the monitoring device 10 also features an adaptation unit 13 that is designed for automatically restricting a not-shown drive unit of the vehicle if it is detected that the person seated in the driver's seat of the vehicle, whose at least one intoxicant content was determined, leaves the driver's seat. For this purpose, the adaptation unit 13 is connected to the second determination unit 12 via a signal line 27.

For example, the starting sequence of the vehicle drive unit is automatically blocked if the vehicle was not yet started. For this purpose, the adaptation unit 13 is connected to the starter 6 via a signal line 26. If the vehicle was already started, it is furthermore possible to reduce the maximum power output of the drive unit and/or the instantaneous power output of the drive unit. In addition, the maximum speed of the vehicle can be reduced. The drive unit furthermore can be automatically deactivated.

In the embodiment shown, the monitoring device 10 furthermore features an arithmetic computing unit 14 and a machine-readable medium 15, wherein a computer program product stored on the machine-readable medium 15 instructs the arithmetic computing unit 14 to carry out the steps mentioned above in connection with the embodiments of the method according to the application, particularly the steps according to the exemplary embodiments illustrated in FIGS. 1 and 2, by means of the respectively cited elements when it is executed on the arithmetic computing unit 14. Although not illustrated in the figures, the arithmetic computing unit 14 is for this purpose directly or indirectly connected to the corresponding elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A method for monitoring an operation of a vehicle, comprising:
determining at least one first parameter, wherein the at least one first parameter characterizes the beginning of a starting sequence of the vehicle,
determining at least one intoxicant content of the person seated in the driver's seat of the vehicle by means of a test instrument and comparing the determined content with a predefined threshold value,
if the determined content does not exceed the predefined threshold value, automatically enabling the starting sequence of the vehicle and detecting if the person seated in the driver's seat of the vehicle, whose at least one intoxicant content was determined, leaves the driver's seat based on data acquired by at least one sensor of the vehicle, and
repeating the determination of the at least one intoxicant content if it is detected that the person seated in the driver's seat of the vehicle, whose at least one intoxicant content was determined, leaves the driver's seat.

2. The method according to claim 1, wherein a drive unit of the vehicle also is automatically restricted if it is detected that the person seated in the driver's seat of the vehicle, whose at least one intoxicant content was determined, leaves the driver's seat.

3. The method according to claim 1, wherein the at least one sensor is realized in the form of a seat occupancy sensor, and wherein the seat occupancy sensor is arranged in the driver's seat.

4. The method according to claim 1, wherein the at least one sensor is realized in the form of an optical camera.

5. The method according to claim 4, wherein the position of the face of the person is determined in the images recorded by the optical camera by means of an image analysis.

6. The method according to claim 5, wherein at least one second parameter is determined if it is detected that the face of the person is at least partially situated outside the acquisition range of the optical camera, and wherein the at least one second parameter characterizes the possibility of the driver leaving the driver's seat.

7. The method according to claim 6, wherein the at least one second parameter is selected from the group consisting of an open state of at least one door of the vehicle and an actuation of the seat belt buckle of the driver's seat.

8. The method according to claim 7, wherein the face of the person situated in the area of the test instrument is also registered during the determination of the at least one intoxicant content by means of an image analysis of the images recorded by the optical camera.

9. The method according to claim 8, wherein the test instrument features at least one light source and the at least one light source is activated at least during the determination of the at least one intoxicant content, and wherein the image analysis includes a determination of the position of the at least one light source in the images recorded by the optical camera.

10. The method according to claim 1, wherein the at least one first parameter is selected from the group consisting of a position of the ignition key of the vehicle and an actuation of the start button of the vehicle.

11. The method according to claim 1, wherein the determination of the at least one intoxicant content includes a determination of the alcohol content of the person seated in the driver's seat of the vehicle.

12. A monitoring device for a vehicle in order to monitor an operation of the vehicle, comprising:
a first determination unit that determines at least one first parameter, wherein the at least one first parameter characterizes the beginning of a starting sequence of the vehicle,
a test instrument that determines at least one intoxicant content of the person seated in the driver's seat of the vehicle and for comparing the determined content with a predefined threshold value, and
a second determination unit that detects if the person seated in the driver's seat of the vehicle, whose at least one intoxicant content was determined, leaves the driver's seat based on data acquired by at least one sensor of the vehicle if the determined content does not exceed the predefined threshold value,
wherein the monitoring unit is designed for automatically enabling the starting sequence of the vehicle if the determined content does not exceed the predefined threshold value, and
wherein the monitoring device is furthermore designed for repeating the determination of the at least one intoxicant content if it is detected that the person seated in the driver's seat of the vehicle, whose at least one intoxicant content was determined, leaves the driver's seat.

13. The monitoring device according to claim 12, wherein the test instrument forms part of an ignition key of the vehicle.

14. A computer readable medium embodying a computer program product that, when executed on an arithmetic computing unit of a vehicle, instructs the arithmetic computing unit to carry out the following steps:
determining at least one first parameter, wherein the at least one first parameter characterizes the beginning of a starting sequence of the vehicle,
determining at least one intoxicant content of the person seated in the driver's seat of the vehicle by means of a test instrument and comparing the determined content with a predefined threshold value,
if the determined content does not exceed the predefined threshold value, automatically enabling the starting sequence of the vehicle and detecting if the person seated in the driver's seat of the vehicle, whose at least one intoxicant content was determined, leaves the driver's seat based on data acquired by at least one sensor of the vehicle, and
repeating the determination of the at least one intoxicant content if it is detected that the person seated in the driver's seat of the vehicle, whose at least one intoxicant content was determined, leaves the driver's seat.

15. (canceled)
